(19) United States
(12) Patent Application Publication
(10) Pub. No.: US 2026/0330750 A1
(43) Pub. Date: Oct. 22, 2026

(54) DATA RENDERING PIPELINE FOR MODELS

(71) Applicant: Comcast Cable Communications, LLC, Philadelphia, PA (US)

(72) Inventors: Raphael Tang, Washington, DC (US); Zhe Wu, Philadelphia, PA (US); Sima Taheri, Philadelphia, PA (US); Ferhan Ture, Washington, DC (US)

(21) Appl. No.: 19/183,511

(22) Filed: Apr. 18, 2025

(51) Int. Cl. G06T 15/20; G06F 16/538; G06T 15/00

(52) U.S. Cl. CPC G06T 15/205; G06F 16/538; G06T 15/005

(57) ABSTRACT

Methods may include receiving, at a computing device, a query from a user device. The query may include one or more of a text portion or an image portion. Methods may include causing, based on the one or more of the text portion or the image portion, a render prompt to be inputted into a multimodal model. The multimodal model may generate, based on at least on the render prompt, image render instructions. The multimodal model may cause the image render instructions to be delivered to an image renderer. Methods may include receiving an image answer rendered from the image renderer based on at least the image render instructions. Methods may include receiving a text answer from the multimodal model. Methods may include generating a response based on at least one of the image answer or the text answer. Methods may include transmitting the response to the user device.

### BACKGROUND

Machine learning models may be used to generate images. The images generated may be unpredictable and may have issues such as unreliability.

Improvements are needed.

### SUMMARY

It is to be understood that both the following general description and the following detailed description are exemplary and explanatory only and are not restrictive. Methods and systems for image rendering pipelines for models, such as large vision language models, are described.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

Methods may include receiving, at a computing device, a query from a user device. The query may include a text portion and an image portion. Methods may include causing the image portion and a spatial perspective prompt to be inputted into a multimodal model. Methods may include receiving spatial perspective information from the multimodal model. Methods may include causing the image portion, the text portion, the spatial perspective information, and a render prompt to be inputted into the multimodal model. The multimodal model may generate, based on at least on the render prompt, image render instructions. The multimodal model may cause the image render instructions to be delivered to an image renderer. Methods may include receiving an image answer rendered from the image renderer based on at least the image render instructions. Methods may include causing the image portion, the text portion, the image answer, and a text generation prompt to be inputted into the multimodal model. Methods may include receiving a text answer from the multimodal model. Methods may include generating a response based on at least one of the image answer or the text answer. Methods may include transmitting the response to the user device. Other embodiments of this aspect include corresponding computer systems, apparatus, and computer programs recorded on one or more computer storage devices, each configured to perform the actions of the methods.

Methods may include receiving, at a computing device, a query from a user device. The query may include one or more of a text portion or an image portion. Methods may include causing, based on the one or more of the text portion or the image portion, a render prompt to be inputted into a multimodal model. The multimodal model may generate, based on at least on the render prompt, image render instructions. The multimodal model may cause the image render instructions to be delivered to an image renderer. Methods may include receiving an image answer rendered from the image renderer based on at least the image render instructions. Methods may include causing, based on at least the image answer, a text generation prompt to be inputted into the multimodal model. Methods may include receiving a text answer from the multimodal model. Methods may include generating a response based on at least one of the image answer or the text answer. Methods may include transmitting the response to the user device. Other embodiments of this aspect include corresponding computer systems, apparatus, and computer programs recorded on one or more computer storage devices, each configured to perform the actions of the methods.

Methods may include receiving, at a computing device, a query from a user device. The query may include one or more of a text portion or an image portion. Methods may include causing, based on the one or more of the text portion or the image portion, a render prompt to be inputted into a first model. The first model may generate, based on at least on the render prompt, image render instructions. The first model may cause the image render instructions to be delivered to an image renderer. Methods may include receiving an image answer rendered from the image renderer based on at least the image render instructions. Methods may include causing, based on at least the image answer, a text generation prompt to be inputted into a second model. Methods may include receiving a text answer from the second model. Methods may include generating a response based on at least one of the image answer or the text answer. Methods may include transmitting the response to the user device. Other embodiments of this aspect include corresponding computer systems, apparatus, and computer programs recorded on one or more computer storage devices, each configured to perform the actions of the methods.

Systems may include one or more processors configured to: receive, at a computing device, a query from a user device, where the query may include a text portion and an image portion; cause the image portion and a spatial perspective prompt to be inputted into a multimodal model; receive spatial perspective information from the multimodal model; cause the image portion, the text portion, the spatial perspective information, and a render prompt to be inputted into the multimodal model, where the multimodal model generates, based on at least on the render prompt, image render instructions, and where the multimodal model causes the image render instructions to be delivered to an image renderer; receive an image answer rendered from the image renderer based on at least the image render instructions; cause the image portion, the text portion, the image answer, and a text generation prompt to be inputted into the multimodal model; receive a text answer from the multimodal model; generate a response based on at least one of the image answer or the text answer; and transmit the response to the user device. Other embodiments of this aspect include corresponding computer systems, apparatus, and computer programs recorded on one or more computer storage devices, each configured to perform the actions of the methods.

Systems may include one or more processors configured to: receive, at a computing device, a query from a user device, where the query may include one or more of a text portion or an image portion; cause, based on the one or more of the text portion or the image portion, a render prompt to be inputted into a multimodal model, where the multimodal model generates, based on at least on the render prompt, image render instructions, and where the multimodal model causes the image render instructions to be delivered to an image renderer; receive an image answer rendered from the image renderer based on at least the image render instructions; cause, based on at least the image answer, a text generation prompt to be inputted into the multimodal model; receive a text answer from the multimodal model; generate a response based on at least one of the image answer or the text answer; and transmit the response to the user device. Other embodiments of this aspect include corresponding computer systems, apparatus, and computer programs recorded on one or more computer storage devices, each configured to perform the actions of the methods.

Systems may include one or more processors configured to: receive, at a computing device, a query from a user device, where the query may include one or more of a text portion or an image portion; cause, based on the one or more of the text portion or the image portion, a render prompt to be inputted into a first model, where the first model generates, based on at least on the render prompt, image render instructions, and where the first model causes the image render instructions to be delivered to an image renderer; receive an image answer rendered from the image renderer based on at least the image render instructions; cause, based on at least the image answer, a text generation prompt to be inputted into a second model; receive a text answer from the second model; generate a response based on at least one of the image answer or the text answer; and transmit the response to the user device. Other embodiments of this aspect include corresponding computer systems, apparatus, and computer programs recorded on one or more computer storage devices, each configured to perform the actions of the methods.

These and other features and advantages are described in greater detail below.

### BRIEF DESCRIPTION OF THE DRAWINGS

Some features are shown by way of example, and not by limitation, in the accompanying drawings. In the drawings, like numerals reference similar elements.

FIG. 1 shows an example environment for image rendering pipelines for models.

FIG. 2 shows an example flow for an image rendering pipeline for models.

FIG. 3 shows an example multimodal input.

FIG. 4 shows an example multimodal output.

FIG. 5 shows an example multimodal input.

FIG. 6 shows an example multimodal output.

FIG. 7 shows an example method in accordance with the present disclosure.

FIG. 8 shows an example method in accordance with the present disclosure.

FIG. 9 shows an example method in accordance with the present disclosure.

The accompanying drawings show examples of the disclosure. It is to be understood that the examples shown in the drawings and/or discussed herein are non-exclusive and that there are other examples of how the disclosure may be practiced.

### DETAILED DESCRIPTION

The accompanying drawings, which form a part hereof, show examples of the disclosure. It is to be understood that the examples shown in the drawings and/or discussed herein are non-exclusive and that there are other examples of how the disclosure may be practiced.

The present disclosure relates to systems and methods for image rendering pipelines for models. The present disclosure relates to systems and methods for driving three dimensional (3D) rendering pipelines. The present disclosure relates to systems and methods for using large vision-language models to render images. The systems and methods disclosed herein may be used for multimodal conversations. For example, a customer may use the systems and methods described herein to submit a query comprising text and one or more images and/or receive a response with text and one or more images. As a further example, a customer may capture an image of a piece of equipment and transmit a query comprising a question about the equipment and the image and receive a response with text and image instructions responding to the question.

The systems and methods disclosed herein may use models, such as multimodal large language models (LLMs), large vision-language models (LVLMs), etc. The systems and methods described herein relate to using models to produce output results in response to an input query. One or both of the input data or the output data may comprise text and images. The systems and methods described herein may comprise a process where a multimodal model may output data into a conventional image rendering pipeline. The systems and methods described herein may use application programming interface (API) calls to interact with one or more multimodal models to choose and/or instruct what functions to choose and/or perform to achieve a target result. The systems and methods described herein may constrain the output text and/or image the rendering process. Functions chosen via the API calls may constrain the output text and/or image. Constraining the output text and/or image may facilitate achieving target parameters.

The systems and methods described herein may be applied in a customer service setting and/or customer assistance setting. A customer may report an issue or make a query with one or more images and text and/or language. The customer may receive a result and/or remedial instructions comprising one or more of text and images.

An angle or point of view of an output image created using the systems and methods described herein may be based on an angle or point of view of a corresponding input image. An angle or point of view of an output image created using the systems and methods described herein may be the same or similar to an angle or point of view of a corresponding input image. An angle or point of view of an output image created using the systems and methods described herein may be based on an angle or point of view of a corresponding input image, but may be different than the angle or point of view of the corresponding input image, pursuant to processing functions, to better illustrate to a user any remedial actions.

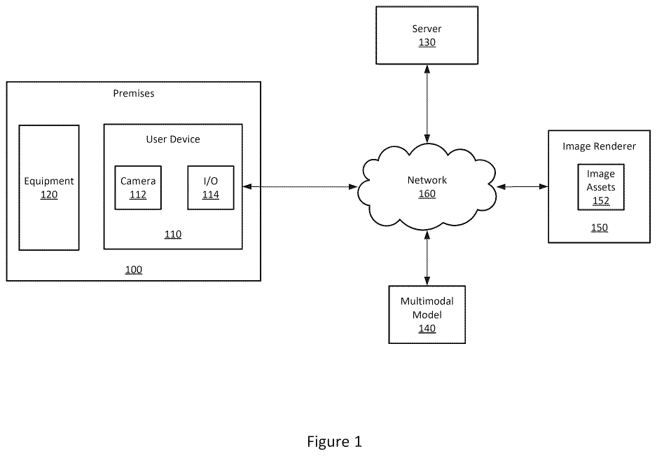

FIG. 1 shows an example environment for image rendering pipelines for models. The environment may comprise a premises 100, a user device 110 on the premises, equipment 120 on the premises, a server 130, a multimodal model 140, an image renderer 150, and a network 160 connecting the user device 110, the server 130, the multimodal model 140, and the image renderer 150. Although shown as connected via the network 160, in other embodiments one or more of the server 130, the multimodal model 140, and the image renderer 150 may be integrated into a single computing device or implemented on multiple computing devices that may communicate without the use of the network 160. The user device 110 may comprise a camera 112 and an input/output interface 114. The image renderer 150 may comprise image assets 152.

The premises 100 may comprise a residential premises. The premises 100 may comprise a commercial premises. The premises 100 may comprise an industrial premises. The premises 100 may be associated with a subscriber of a service provider. The service provider may provide access to the network 160. The service provider may provide access to the server 130.

The user device 110 may be associated with the service provider. The user device 105 may be associated with the subscriber. The user device 110 may comprise one or more of a smartphone, tablet, laptop, desktop computer, wearable computing device, etc. The user device 110 may comprise an application (front-end, etc.). The application may be associated with the service provider. The application may provide the user device 110 with access to the server 130 via the network 160. The camera 112 may be used to capture images. The user device 110 may be configured to receive images from a separate camera. The input/output interface 114 may be used to input text. The input/output interface 114 may be used to input instructions, such as selection of an image, confirmation of a send, etc. The input/output interface 114 may be used to view images and/or text. The input/output interface 114 may comprise one or more of a touchscreen, keyboard, mouse, touchpad, microphone, etc. The input/output interface 114 may comprise one or more of a display, speakers, etc.

The equipment 120 may be associated with the service provider. The equipment 120 may be associated with the subscriber. The equipment 120 may comprise one or more of set-top box, modem, gateway, router, etc.

The server 130 may comprise one or more servers. The server 130 may reside in a cloud computing environment. The server 130 may be associated with the service provider. The server 130 may comprise an application programming interface (API). The server 130 may communicate with one or more of the user device 110, the multimodal model 140, or the image renderer 150 with API calls and/or responses.

The multimodal model 140 may comprise a multimodal large language model (LLM) The multimodal model 140 may comprise a large vision-language model (LVLM). Although shown as singular, the functions of the multimodal model 140 may be performed by multiple models. For example, a first model may be trained to receive an image and return a text description of the perspective and/or point of view of the image. As another example, a second model may be trained to receive the image, the text description of the perspective and/or point of view of the image, and a query, and return text instructions for rendering an image. As another example, a third model may be trained to receive the image and the query and return a text answer based on a library of predefined answers. The multimodal model 140 may comprise an application programming interface (API). The multimodal model 140 may communicate with one or more of the server 130, the image renderer 150, or the user device 110 with API calls and/or responses.

The image renderer 150 may comprise a three dimensional (3D) modeling suite. The image renderer 150 may create images based on rendering instructions. The image assets 152 may be associated with the service provider. The image assets 152 may comprise 3D representations of equipment, such as the equipment 120, associated with the service provider. The image assets 152 may comprise 3D representations of components of equipment. The image assets 152 may comprise assets over which the service provider has a legal right to copy, distribute, make derivative works, etc.

The network 160 may comprise a public network, such as the Internet. The network 160 may comprise a private network. The network 160 may comprise a blockchain network. The network 160 may be associated with the service provider.

The server 130 may receive a query from the user device 110. The query may comprise an image portion and a text portion. The server 130 may cause a spatial perspective prompt and the image portion to be inputted into the multimodal model 140. The multimodal model 140 may return spatial perspective information to the server 130. The server 130 may cause the image portion, the text portion, the spatial perspective information, and a render prompt to be inputted into the multimodal model 140. The multimodal model 140 may generate image render instructions and provide the image render instructions to the image renderer 150. The image renderer 150 may render an image answer based on the image render instructions. The server 130 may receive the image answer. The server 130 may cause the image portion, the text portion, the image answer, and a text generation prompt to be inputted into the multimodal model 140. The multimodal model 140 may return a text answer to the server 130. The server 130 may generate a response based on the image answer and the text answer. The server 130 may transmit the response to the user device 110 via the network 160.

A user at the premises 100 may have a problem with the equipment 120. The user may use the camera 112 of the user device 110 to capture an image of the equipment 120. The user may use the input/output interface 114 to enter a question about the equipment 120 and transmit a query to the server 130 via the network 160, wherein the query comprises the image of the equipment 120 and the question about the equipment 120. The server 130 may cause a spatial perspective prompt and the image of the equipment 120 to be inputted into the multimodal model 140. The multimodal model 140 may return spatial perspective information to the server 130. The spatial perspective information may be indicative of a camera angle, point-of-view, and/or perspective associated with the image of the equipment 120.

The server 130 may cause the image of the equipment 120, the question about the equipment 120, the spatial perspective information, and a render prompt to be inputted into the multimodal model 140. The multimodal model 140 may generate image render instructions and provide the image render instructions to the image renderer 150. The image renderer 150 may render an image answer based on the image render instructions. The image answer may comprise a 3-D asset. The 3-D asset may be a representation of the equipment 120. The image answer may comprise a same or similar camera angle, point-of-view, and/or perspective as the camera angle, point-of-view, and/or perspective indicated by the spatial perspective information. The server 130 may receive the image answer.

The server 130 may cause the image of the equipment 120, the question about the equipment 120, the image answer, and a text generation prompt to be inputted into the multimodal model 140. The multimodal model 140 may use a retrieval augmented generation (RAG) framework to generate a text answer. The RAG framework may comprise articles and/or text about equipment associated with the service provider. The service provider may have a legal right to copy, distribute, make derivative works of, etc. the articles and/or text contained in the RAG framework. The text answer may comprise and/or be based on one or more of the articles and/or text. The multimodal model 140 may return the text answer to the server 130. The server 130 may generate a response based on the image answer and the text answer. The server 130 may transmit the response to the user device 110 via the network 160.

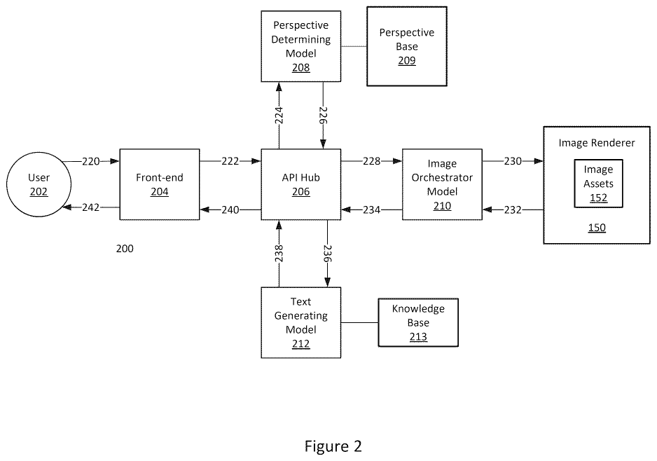

FIG. 2 shows an example flow 200 for an image rendering pipeline for models. The example flow 200 may comprise a user 202, a front-end 204, an application programming interface (API) hub 206, a perspective determining model 208, an image orchestrator model 210, the image renderer 150 of FIG. 1, and a text generating model 212. The front-end 204 may comprise an application executing on the user device 110 in FIG. 1. The API hub 206 may be associated with the server 130 in FIG. 1. The API hub 206 may comprise a representational state transfer (REST or RESTful) API. The perspective determining model 208, the image orchestrator model 210, and the text generating model 212 may be separate, as shown. Although shown as separate, two or more of the perspective determining model 208, the image orchestrator model 210, and the text generating model 212 may reside in a single model, such as the multimodal model 140 in FIG. 1. The examples used in reference to FIG. 2 are non-limiting and other images, queries, and end uses may be used without departing from the spirit of the present disclosure.

The perspective determining model 208 may be trained on a perspective base 209. The perspective base 209 may comprise images from various perspectives and associated descriptions of the perspective. The text generating model 212 may be trained on a knowledge base 213. The knowledge base 213 may be provided within a retrieval augmented generation (RAG) framework. The knowledge base 213 may be associated with the service provider. The knowledge base 213 may comprise text, articles, how to guides, frequently asked questions, etc. associated with the service provider. The knowledge base 213 may comprise images and/or questions and associated relevant text. The image renderer 150 may comprise the image assets 152 in FIG. 1.

At step 220, a user 202 may input a query and an image into the front-end 204. At step 222, the front-end 204 may transmit the query and the image to the API hub 206. At step 224, the API hub 206 may cause the image to be inputted into the perspective determining model 208. At step 226, the perspective determining model 208 may return spatial perspective information to the API hub 206.

At step 228, the API hub 206 may cause the spatial perspective information, the query, and the image to be inputted into the image orchestrator model 210, wherein the image orchestrator model 210 generates image rendering instructions. At step 230, the image orchestrator model 210 may cause the image and the image rendering instructions to be inputted into the image renderer 150. The image renderer 150 may use the image assets 152 to create a rendered image. The rendered image may comprise a 3D asset representative of an object in the image. The rendered image may comprise the 3D asset comprising a spatial perspective similar to a spatial perspective of the object in the image. The rendered image may comprise one or more image assets 152 representative of components. The one or more components may be based on the query. The one or more components may be arranged within the 3D asset. At step 232, the image renderer 150 may return the rendered image to the image orchestrator model 210.

The image orchestrator model 210 may create an image answer based on the rendered image. At step 234, the image orchestrator model 210 may transmit the image answer to the API hub 206. At step 236, the API hub may cause the image, the query, and the image answer to be inputted into the text generating model 212. The text generating model 212 may use the knowledge base 213 to generate a text answer. At step 238, the text generating model 212 may return the text answer to the API hub 206. At step 240, the API hub 206 may return the text answer and the image answer to the front-end 204. The text answer and the image answer may be returned in a single message. At step 242, the text answer and the image answer may be output by the front-end 204 to the user 202.

The user 202 may capture an image of equipment and compose a query about connecting the equipment to other equipment in the front-end 204 at step 220. At step 222, the front-end 204 may transmit the image of the equipment and the query about connecting the equipment to other equipment to the API hub 206. The API hub 206 may cause the image of the equipment to be inputted into the perspective determining model 208 at step 224. At step 226, a description of a spatial perspective related to the equipment in the image may be returned to the API hub 206. At step 228, the API hub 206 may cause the spatial perspective related to the equipment in the image, the query about connecting the equipment to other equipment, and the image of the equipment to be inputted into the image orchestrator model 210, wherein the image orchestrator model 210 generates image rendering instructions.

At step 230, the image orchestrator model 210 may cause the image of the equipment and the image rendering instructions to be inputted into the image renderer 150. The image renderer 150 may use the image assets 152 to create a rendered image. The rendered image may comprise a 3D asset representative of the equipment. The rendered image may comprise the 3D asset comprising a spatial perspective similar to a spatial perspective of the equipment in the image. The rendered image may comprise connection link (wire, cable, etc.). The connection link may be based on the query. The connection link may be arranged on the 3D representation of the equipment where the connection link couples with the equipment. The connection link and/or the location of the connection link on the equipment may be highlighted in the rendered image. At step 232, the image renderer 150 may return the rendered image of the equipment and connection link to the image orchestrator model 210.

The image orchestrator model 210 may create an image answer based on the rendered image of the equipment and connection link. At step 234, the image orchestrator model 210 may transmit the image answer to the API hub 206. At step 236, the API hub may cause the image of the equipment, the query about connecting the equipment to other equipment, and the image answer to be inputted into the text generating model 212. The text generating model 212 may use the knowledge base 213 to generate a text answer. The text answer may comprise a frequently asked questions article about connecting the equipment to the other equipment. At step 238, the text generating model 212 may return the text answer to the API hub 206. At step 240, the API hub 206 may return the text answer and the image answer to the front-end 204. The text answer and the image answer may be returned in a single message. At step 242, the text answer and the image answer may be output by the front-end 204 to the user 202.

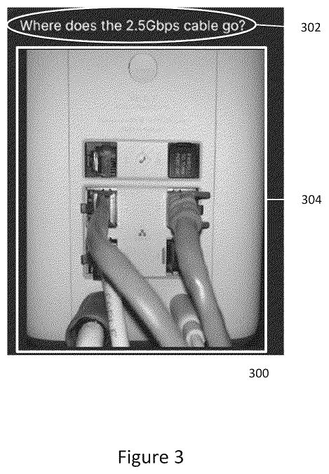

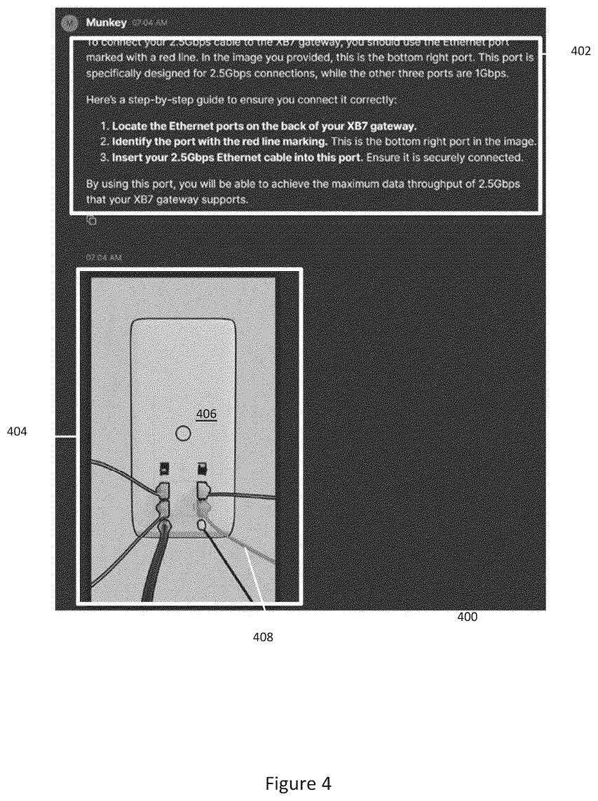

FIG. 3 shows an example multimodal input 300. The input 300 may comprise a text portion 302. The input 300 may comprise an image portion 304. The text portion 302 may comprise a query. The image portion 304 may comprise an image of equipment. The input 300 may be submitted to the systems and methods described herein. FIG. 4 shows an example multimodal output 400. In response to receiving the input 300 in FIG. 3, the systems and methods described herein may generate the output 400. The output 400 may comprise a text answer 402 and an image answer 404. The text answer 402 may comprise text related to the query. The text answer 402 may comprise text related to information found within a retrieval augmented generation (RAG) framework.

The image answer 404 may comprise a three dimensional (3D) image asset of the equipment (equipment asset) 406. The equipment asset 406 may be a representation of the equipment in the image in the image portion 304 of the input 300. A camera angle (perspective, point-of-view) of the equipment asset 406 in the image answer 404 may match and/or be similar to a camera angle of the equipment in the image portion 304 of the input 300. The image answer 404 may comprise a 3D asset representation of a component (component asset) 408. The component asset 408 may comprise an emphasis, such as a highlighting. The component asset 408 may be placed in a location relative to the image asset 406 to address the query. For example, the query may be related to placement of the component within the equipment, and the image answer 404 may demonstrate proper placement of the component asset 408 within the equipment asset 406.

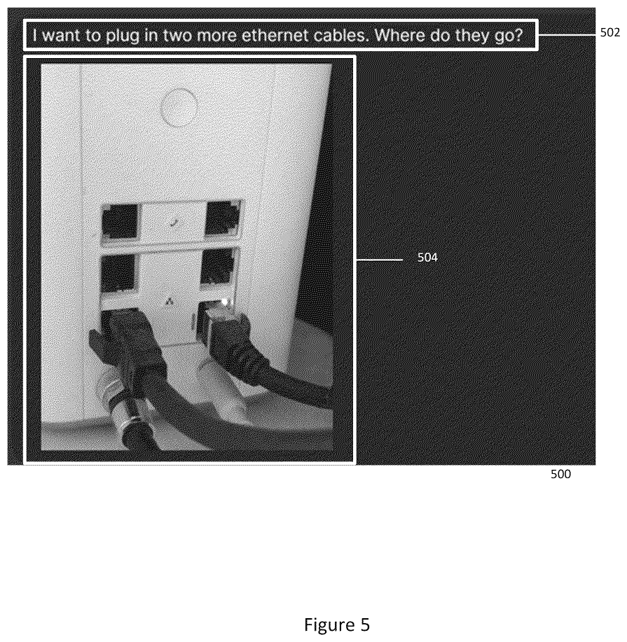

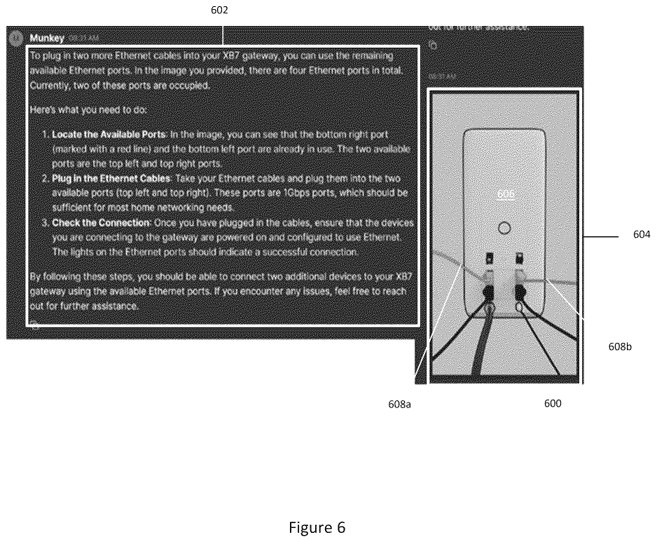

FIG. 5 shows an example multimodal input 500. The input 500 may comprise a text portion 502. The input 500 may comprise an image portion 504. The text portion 502 may comprise a query. The image portion 504 may comprise an image of equipment. The input 500 may be submitted to the systems and methods described herein. FIG. 6 shows an example multimodal output 600. In response to receiving the input 500 in FIG. 5, the systems and methods described herein may generate the output 600. The output 600 may comprise a text answer 602 and an image answer 604. The text answer 602 may comprise text related to the query. The text answer 602 may comprise text related to information found within a retrieval augmented generation (RAG) framework.

The image answer 604 may comprise a three dimensional (3D) image asset of the equipment (equipment asset) 606. The equipment asset 606 may be a representation of the equipment in the image in the image portion 504 of the input 500. A camera angle (perspective, point-of-view) of the equipment asset 606 in the image answer 604 may match and/or be similar to a camera angle of the equipment in the image portion 604 of the input 500. The image answer 604 may comprise a 3D asset representation of components (component assets) 608a, 608b. The component assets 608a, 608b may comprise an emphasis, such as a highlighting. The component assets 608a, 608b may be placed in locations relative to the image asset 606 to address the query. For example, the query may be related to placement of the components within the equipment, and the image answer 604 may demonstrate proper placement of the component assets 608a, 608b within the equipment asset 606.

### EXAMPLES

Most conversational virtual assistants are text-based, with few taking images as input and even fewer also giving images as output. Adopting a text-only approach worsens the user experience because customers must not only describe their real-life problems in writing but also translate textual responses to physical actions. Described herein are vision-language systems and methods for adding image input and image output to conversational agents (chatbots, etc.). Rather than following a fully generative artificial intelligence (AI) paradigm, where a diffusion model synthesizes images from scratch, the hybrid approach described herein uses a multimodal large language model (LLM) to make function calls into a conventional 3D rendering pipeline. The systems and methods described herein enable precise control over a visual scene, a crucial safety requirement for commercial applications. An experiment on router troubleshooting was used to test the systems and methods described herein, demonstrating a working prototype for solving issues on a modem.

As an illustrative example, a broadband customer may experience router issues. The router often gives visual cues about the problem, such as red lights and misplaced connectors. Conventionally, the customer would then engage with a virtual text-based assistant from their internet service provider, but the customer would encounter several challenges still: first, the customer must describe a visual problem in written language. Second, the customer must translate textual responses from the virtual assistant to physical actions and solutions, further increasing the cognitive burden. The cognitive burden may be called a modality translation bottleneck—where a bottleneck between the customer's modalities (vision, language, and touch, i.e., the real world) and the virtual assistant's (language only) worsens user experience due to extra cognitive load.

To ameliorate the modality translation bottleneck, the systems and methods described herein add image input and image output to virtual customer assistants. Multimodal language models, such as OpenAI's GPT-4o, may be used to support image input. Multimodal language models may have a strong ability to understand images. For image output, modern generative machine learning literature suggests to apply text-to-image diffusion models, e.g., Stable Diffusion and DALL-E 3; however, industrial practitioners find an approach using the text-to-image diffusion models legally problematic because the text-to-image diffusion models lack controllability and copyright safety. Thus, the systems and methods described herein use a conventional rendering pipeline and a multimodal LLM that calls and manipulates the pipeline for image output.

Specifically, given user input, the systems and methods described herein make predefined API calls into a 3D rendering pipeline, with the scene geometry and materials premodeled in a computer graphics toolset, such as an image renderer, such as Blender3D, for example. Such API calls may include editing the mesh colors (e.g., the indicator lighting), highlighting subobjects (e.g., cables), and drawing meshes to generate an image answer for the customer. The systems and methods described herein have the benefits of customization and flexibility while eliminating the potential downsides of copyright infringement and offensive image output.

A prototypical system encompassing the systems and methods described herein were implemented on a virtual assistant serving a content delivery segment of a business to perform an experimentation of the systems and methods described herein. The experimentation demonstrated that the prototypical system can capably recognize and troubleshoot issues with a router. Compared to an existing text-based assistant, the prototypical system solved equivalent issues using fewer dialogue turns.

The systems and methods described herein comprise a novel hybrid framework for vision-language virtual assistance. To handle image input, a standard multimodal LLM may be used. For image output, the multimodal LLM may be hooked into a conventional rendering pipeline. An API may be exposed for the LLM to dynamically edit a premodeled graphical scene.

A working proof-of-concept extending a virtual assistant was implemented to demonstrate the practical feasibility of the systems and methods described herein.

Given a customer text query xₜₑₓₜ and image input x_{image}, a target of the experiment was to produce a text response yₜₑₓₜ and image y_{image} answering the user queries. For example, xₜₑₓₜ may be “why does my router not work?” and x_{image} a picture of a router with a red light. The standard approach to generate yₜₑₓₜ conditioned on xₜₑₓₜ and x_{image} is to use a multimodal LLM, such as GPT-4o, for example. Several methods exist for generating y_{image}, most prominently fine-tuning diffusion models. However, in practice fully generative approaches suffer from copyright infringement, obscene image generation, and other legal issues, resulting in ongoing litigation against models, such as Stable Diffusion, for example.

Instead, the systems and methods follow a conventional 3D content generation paradigm, such as Blender3D, enabling precise control, then implement an API which allows for customization of the 3D scene. For example, a 3D scene may comprise a router and the API may comprise functions configured to may changes to the 3D scene, such as change the router lighting, attached cables, highlighted areas, etc. A multimodal function-calling LLM may be connected to the API to dynamically generate appropriate 3D images in response to user queries. For instance, given the query “where does the ethernet cable go?” and a picture of the back of a router, the LLM may call the 3D API with the appropriate arguments to generate a representation of the back of the router with a highlighted cable connecting to a representation of an appropriate connection point. For improved customer experience, an camera angle associated with an input image may be determined and an associated output image may be generated with an orientation mimicking the same or a similar camera angle.

Concretely, let a 3D scene be (M, θ, φ), where [symbol] is a collection of 3D objects and θ and φ are the azimuth and elevation camera angles. Let f( [symbol] ; θ, φ) be a rendering function that takes in a 3D scene and outputs a generated image y_{image}. A set of API functions gi: [symbol] × [symbol] ᵢ [symbol] [symbol] for 1≤i≤n that modifies the collection of models [symbol] for function calling parameters [symbol] ᵢ may be given. For example, a function modifying the color of the indicator light could have the definition g_{light}: [symbol] ×{“red”, “green”, “white”} [symbol] [symbol] . As shown in FIG. 2, the systems and methods described herein may comprise three main steps: first, solving for a camera pose θ and φ of a provided image using a multimodal LLM. Second, using the multimodal LLM to call functions

$${\{ {g}_{i} \}}_{i = 0}^{n}$$

to generate an appropriate image answer to xₜₑₓₜ and x_{image}, which certain LLMs may exhibit desirable proficiency at addressing. Finally, using the multimodal LLM to produce a textual response, and sending both the image answer and the textual response to the user.

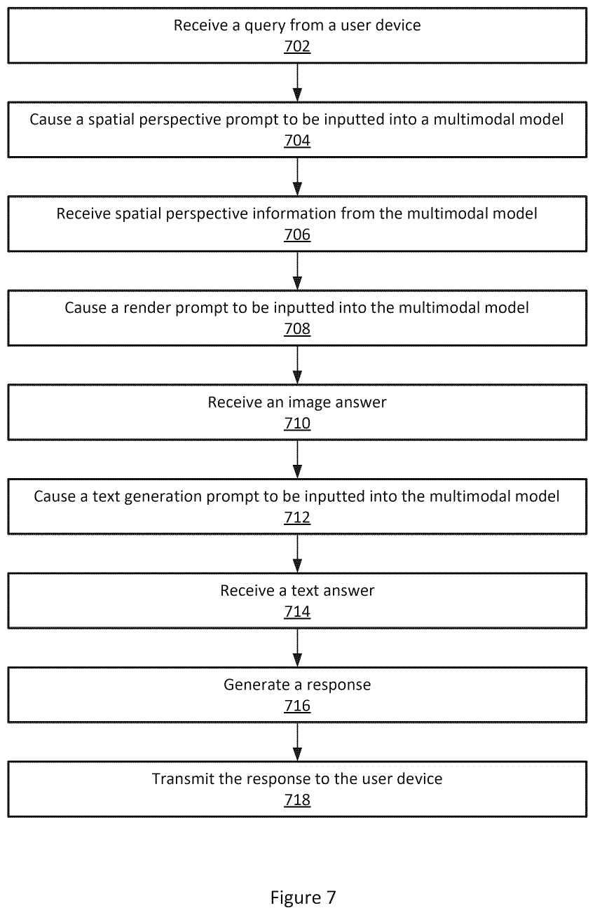

FIG. 7 is a flowchart of an example process 700. In some implementations, one or more process blocks of FIG. 7 may be performed by the server 130 in FIG. 1.

As shown in FIG. 7, process 700 may include receiving a query from a user device (block 702). The query may be received at a computing device. For example, the server 130 may receive a query from a user device. The query may include a text portion and an image portion.

As also shown in FIG. 7, process 700 may include causing a spatial perspective prompt to be inputted into a multimodal model (block 704). For example, the server 130 may cause a spatial perspective prompt to be inputted into a multimodal model. Causing the spatial perspective prompt to be inputted into the multimodal model may comprise causing the image portion to be inputted into the multimodal model. The spatial perspective information may comprise camera angle information.

As further shown in FIG. 7, process 700 may include receiving spatial perspective information from the multimodal model (block 706). For example, the server 130 may receive spatial perspective information from the multimodal model.

As also shown in FIG. 7, process 700 may include causing a render prompt to be inputted into the multimodal model (block 708). For example, the server 130 may cause a render prompt to be inputted into the multimodal model. Causing the render prompt to be inputted into the multimodal model may comprise causing one or more of the image portion, the text portion, or the spatial perspective information to be inputted into the multimodal model. The multimodal model may generate, based on at least on the render prompt, image render instructions. The multimodal model may cause the image render instructions to be delivered to an image renderer.

The image render instructions may comprise at least one instruction to retrieve at least one first stored image asset. The image render instructions may comprise at least one instruction to cause the at least one first stored image asset to be displayed according to the spatial perspective information. The at least one first stored image asset may be retrieved based on the image portion. The image render instructions may comprise at least one instruction to retrieve at least one second stored image asset based on the text portion. The image render instructions may comprise at least one instruction to highlight the at least one second stored image asset. The image render instructions may comprise at least one instruction indicative of a location of the at least one second stored image asset relative to the at least one first stored image asset.

As further shown in FIG. 7, process 700 may include receiving an image answer (block 710). For example, the server 130 may receive an image answer. The image answer may be rendered from the image renderer. The image answer may be rendered based on at least the image render instructions.

As also shown in FIG. 7, process 700 may include causing a text generation prompt to be inputted into the multimodal model (block 712). For example, the server 130 may cause a text generation prompt to be inputted into the multimodal model. Causing the text generation prompt to be inputted into the multimodal model may comprise causing one or more of the image portion, the text portion, or the image answer to be inputted into the multimodal model.

As further shown in FIG. 7, process 700 may include receiving a text answer (block 714). For example, the server 130 may receive a text answer. The text answer may be received from the multimodal model.

As also shown in FIG. 7, process 700 may include generating a response (block 716). For example, the server 130 may generate a response. The response may be generated based on at least one of the image answer or the text answer. The generating a response based on at least one of the image answer or the text answer may comprise combining the image answer and the text answer into the response.

As further shown in FIG. 7, process 700 may include transmitting the response to the user device (block 718). For example, the server 130 may transmit the response to the user device.

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel.

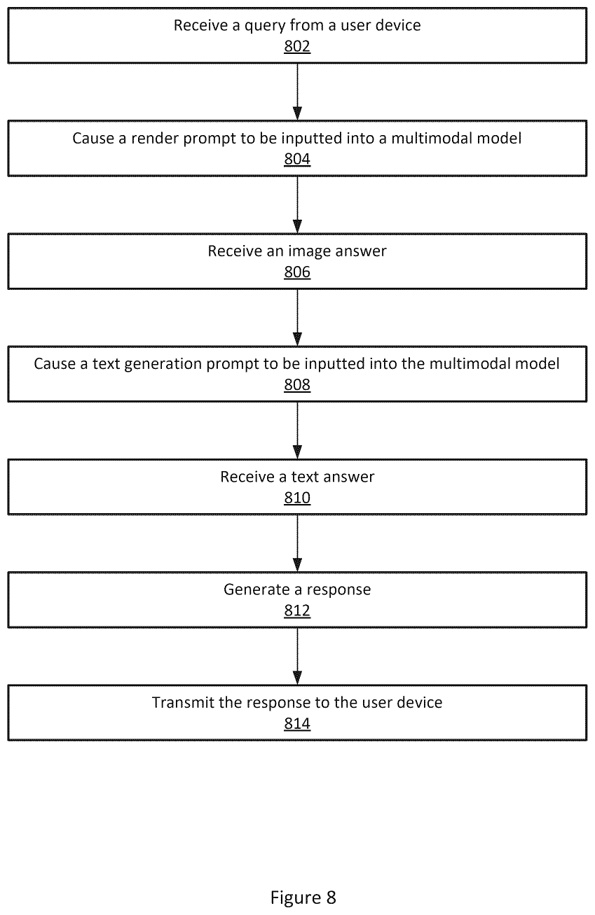

FIG. 8 is a flowchart of an example process 800. In some implementations, one or more process blocks of FIG. 8 may be performed by the server 130 in FIG. 1.

As shown in FIG. 8, process 800 may include receiving a query from a user device (block 802). The query may be received at a computing device. For example, the server 130 may receive a query from a user device. The query may include a text portion and an image portion.

As also shown in FIG. 8, process 800 may include causing a render prompt to be inputted into a multimodal model (block 804). For example, the server 130 may cause a render prompt to be inputted into a multimodal model. The render prompt may be based on the one or more of the text portion or the image portion. The multimodal model may generate, based on at least on the render prompt, image render instructions. The multimodal model may cause the image render instructions to be delivered to an image renderer.

Process 800 may include causing the image portion and a camera angle prompt to be inputted into the multimodal model. For example, the server 130 may cause the image portion and a camera angle prompt to be inputted into the multimodal model. Process 800 may include receiving camera angle information from the multimodal model. For example, the server 130 may receive camera angle information from the multimodal model. The render prompt may be further based on the camera angle information.

The image render instructions may comprise at least one instruction to retrieve at least one first stored image asset. The image render instructions may comprise at least one instruction to cause the at least one first stored image asset to be displayed according to the camera angle information. The at least one first stored image asset may be retrieved based on the image portion. The image render instructions may comprise at least one instruction to retrieve at least one second stored image asset based on the text portion. The image render instructions may comprise at least one instruction to highlight the at least one second stored image asset. The image render instructions may comprise at least one instruction indicative of a location of the at least one second stored image asset relative to the at least one first stored image asset.

As further shown in FIG. 8, process 800 may include receiving an image answer (block 806). For example, the server 130 may receive an image answer. The image answer may be rendered from the image renderer. The image answer may be rendered based on at least the image render instructions.

As also shown in FIG. 8, process 800 may include causing a text generation prompt to be inputted into the multimodal model (block 808). For example, the server 130 may cause a text generation prompt to be inputted into the multimodal model. The text generation prompt may be based on at least the image answer. The text generation prompt may be further based on one or more of the text portion or the image portion.

As further shown in FIG. 8, process 800 may include receiving a text answer (block 810). For example, the server 130 may receive a text answer. The text answer may be received from the multimodal model.

As also shown in FIG. 8, process 800 may include generating a response (block 812). For example, the server 130 may generate a response. The response may be generated based on at least one of the image answer or the text answer. The generating a response may comprise combining the image answer and the text answer into the response.

As further shown in FIG. 8, process 800 may include transmitting the response to the user device (block 814). For example, the server 130 may transmit the response to the user device.

Although FIG. 8 shows example blocks of process 800, in some implementations, process 800 may include additional blocks, fewer blocks, different blocks, or differently arranged blocks than those depicted in FIG. 8. Additionally, or alternatively, two or more of the blocks of process 800 may be performed in parallel.

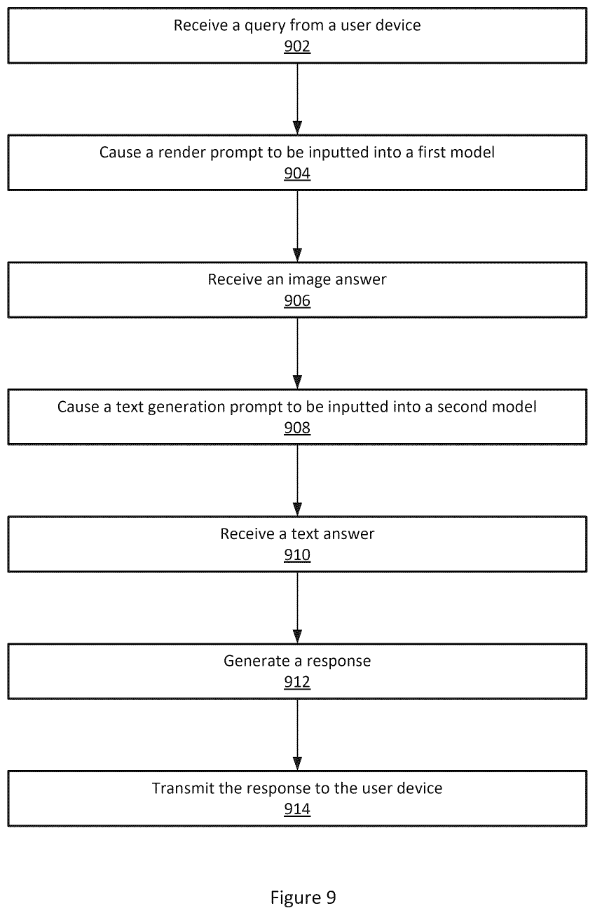

FIG. 9 is a flowchart of an example process 900. In some implementations, one or more process blocks of FIG. 9 may be performed by the server 130 in FIG. 1.

As shown in FIG. 9, process 900 may include receiving a query from a user device (block 902). The query may be received at a computing device. For example, the server 130 may receive a query from a user device. The query may include a text portion and an image portion.

As also shown in FIG. 9, process 900 may include causing a render prompt to be inputted into a first model (block 904). For example, the server 130 may cause a render prompt to be inputted into a first model. The render prompt may be based on the one or more of the text portion or the image portion. The first model may generate, based on at least on the render prompt, image render instructions. The first model may cause the image render instructions to be delivered to an image renderer. The first model may be configured to generate instructions for the image renderer.

As further shown in FIG. 9, process 900 may include receiving an image answer (block 906). For example, the server 130 may receive an image answer. The image answer may be rendered from the image renderer. The image answer may be rendered based on at least the image render instructions.

As also shown in FIG. 9, process 900 may include causing a text generation prompt to be inputted into a second model (block 908). For example, the server 130 may cause a text generation prompt to be inputted into a second model. The text generation prompt may be based on at least the image answer. The text generation prompt may be further based on one or more of the text portion or the image portion. The second model may be configured to generate a text response. The second model may be configured to use a retrieval-augmented generation (RAG) system.

As further shown in FIG. 9, process 900 may include receiving a text answer (block 910). For example, the server 130 may receive a text answer. The text answer may be received from the second model.

As also shown in FIG. 9, process 900 may include generating a response (block 912). For example, the server 130 may generate a response. The response may be generated based on at least one of the image answer or the text answer. The generating a response may comprise combining the image answer and the text answer into the response.

As further shown in FIG. 9, process 900 may include transmitting the response to the user device (block 914). For example, the server 130 may transmit the response to the user device.

Process 900 may include causing the image portion and a camera angle prompt to be inputted into a third model. For example, the server 130 may cause the image portion and a camera angle prompt to be inputted into a third model. Process 800 may include receiving camera angle information from the third model. For example, the server 130 may receive camera angle information from the third model. The render prompt may be further based on the camera angle information.

The image render instructions may comprise at least one instruction to retrieve at least one first stored image asset. The image render instructions may comprise at least one instruction to cause the at least one first stored image asset to be displayed according to the camera angle information. The at least one first stored image asset may be retrieved based on the image portion. The image render instructions may comprise at least one instruction to retrieve at least one second stored image asset based on the text portion. The image render instructions may comprise at least one instruction to highlight the at least one second stored image asset. The image render instructions may comprise at least one instruction indicative of a location of the at least one second stored image asset relative to the at least one first stored image asset.

The third model may be configured to determine a spatial perspective. The third model may be configured to receive an image and determine a camera angle associated with the image.

Although FIG. 9 shows example blocks of process 900, in some implementations, process 900 may include additional blocks, fewer blocks, different blocks, or differently arranged blocks than those depicted in FIG. 9. Additionally, or alternatively, two or more of the blocks of process 900 may be performed in parallel.

Example Clause 1: A method may include: receiving, at a computing device, a query from a user device, where the query may include a text portion and an image portion; causing the image portion and a spatial perspective prompt to be inputted into a multimodal model; receiving spatial perspective information from the multimodal model; causing the image portion, the text portion, the spatial perspective information, and a render prompt to be inputted into the multimodal model, where the multimodal model generates, based on at least on the render prompt, image render instructions, and where the multimodal model causes the image render instructions to be delivered to an image renderer; receiving an image answer rendered from the image renderer based on at least the image render instructions; causing the image portion, the text portion, the image answer, and a text generation prompt to be inputted into the multimodal model; receiving a text answer from the multimodal model; generating a response based on at least one of the image answer or the text answer; and transmitting the response to the user device.

Example Clause 2: The method of Example Clause 1, where the spatial perspective information may include camera angle information.

Example Clause 3: The method of Example Clause 1 or Example Clause 2, where the image render instructions may include at least one instruction to retrieve at least one first stored image asset.

Example Clause 4: The method of any one of Example Clauses 1-3, where the image render instructions may include at least one instruction to cause the at least one first stored image asset to be displayed according to the spatial perspective information.

Example Clause 5: The method of any one of Example Clauses 1-4, where the at least one first stored image asset is retrieved based on the image portion.

Example Clause 6: The method of any one of Example Clauses 1-5, where the image render instructions may include at least one instruction to retrieve at least one second stored image asset based on the text portion.

Example Clause 7: The method of any one of Example Clauses 1-6, where the image render instructions may include at least one instruction to highlight the at least one second stored image asset.

Example Clause 8: The method of any one of Example Clauses 1-7, where the image render instructions may include at least one instruction indicative of a location of the at least one second stored image asset relative to the at least one first stored image asset.

Example Clause 9: The method of any one of Example Clauses 1-8, where the generating a response based on at least one of the image answer or the text answer may include combining the image answer and the text answer into the response.

Example Clause 10: A method may include: receiving, at a computing device, a query from a user device, where the query may include one or more of a text portion or an image portion; causing, based on the one or more of the text portion or the image portion, a render prompt to be inputted into a multimodal model, where the multimodal model generates, based on at least on the render prompt, image render instructions, and where the multimodal model causes the image render instructions to be delivered to an image renderer; receiving an image answer rendered from the image renderer based on at least the image render instructions; causing, based on at least the image answer, a text generation prompt to be inputted into the multimodal model; receiving a text answer from the multimodal model; generating a response based on at least one of the image answer or the text answer; and transmitting the response to the user device.

Example Clause 11: The method of Example Clause 10, further may include: causing the image portion and a camera angle prompt to be inputted into the multimodal model; receiving camera angle information from the multimodal model; and where the render prompt is further based on the camera angle information.

Example Clause 12: The method of Example Clause 10 or Example Clause 11, where the image render instructions may include at least one instruction to retrieve at least one first stored image asset.

Example Clause 13: The method of any one of Example Clauses 10-12, where the image render instructions may include at least one instruction to cause the at least one first stored image asset to be displayed according to the camera angle information.

Example Clause 14: The method of any one of Example Clauses 10-13, where the at least one first stored image asset is retrieved based on the image portion.

Example Clause 15: The method of any one of Example Clauses 10-14, where the image render instructions may include at least one instruction to retrieve at least one second stored image asset based on the text portion.

Example Clause 16: The method of any one of Example Clauses 10-15, where the image render instructions may include at least one instruction to highlight the at least one second stored image asset.

Example Clause 17: The method of any one of Example Clauses 10-16, where the image render instructions may include at least one instruction indicative of a location of the at least one second stored image asset relative to the at least one first stored image asset.

Example Clause 18: The method of any one of Example Clauses 10-17, where the generating a response based on at least one of the image answer or the text answer may include combining the image answer and the text answer into the response.

Example Clause 19: The method of any one of Example Clauses 10-18, where the text generation prompt is further based on one or more of the text portion or the image portion.

Example Clause 20: A method may include: receiving, at a computing device, a query from a user device, where the query may include one or more of a text portion or an image portion; causing, based on the one or more of the text portion or the image portion, a render prompt to be inputted into a first model, where the first model generates, based on at least on the render prompt, image render instructions, and where the first model causes the image render instructions to be delivered to an image renderer; receiving an image answer rendered from the image renderer based on at least the image render instructions; causing, based on at least the image answer, a text generation prompt to be inputted into a second model; receiving a text answer from the second model; generating a response based on at least one of the image answer or the text answer; and transmitting the response to the user device.

Example Clause 21: The method of Example Clause 20, further may include causing the image portion and a camera angle prompt to be inputted into a third model; receiving camera angle information from the third model; and where the render prompt is further based on the camera angle information.

Example Clause 22: The method of Example Clause 20 or Example Clause 21, where the image render instructions may include at least one instruction to retrieve at least one first stored image asset.

Example Clause 23: The method of any one of Example Clauses 20-22, where the image render instructions may include at least one instruction to cause the at least one first stored image asset to be displayed according to the camera angle information.

Example Clause 24: The method of any one of Example Clauses 20-23, where the at least one first stored image asset is retrieved based on the image portion.

Example Clause 25: The method of any one of Example Clauses 20-24, where the image render instructions may include at least one instruction to retrieve at least one second stored image asset based on the text portion.

Example Clause 26: The method of any one of Example Clauses 20-25, where the image render instructions may include at least one instruction to highlight the at least one second stored image asset.

Example Clause 27: The method of any one of Example Clauses 20-26, where the image render instructions may include at least one instruction indicative of a location of the at least one second stored image asset relative to the at least one first stored image asset.

Example Clause 28: The method of any one of Example Clauses 20-27, where the third model is configured to determine a spatial perspective.

Example Clause 29: The method of any one of Example Clauses 20-28, where the third model is configured to receive an image and determine a camera angle associated with the image.

Example Clause 30: The method of any one of Example Clauses 20-29, where the generating a response based on at least one of the image answer or the text answer may include combining the image answer and the text answer into the response.

Example Clause 31: The method of any one of Example Clauses 20-30, where the text generation prompt is further based on one or more of the text portion or the image portion.

Example Clause 32: The method of any one of Example Clauses 20-31, where the first model is configured to generate instructions for the image renderer.

Example Clause 33: The method of any one of Example Clauses 20-32, where the second model is configured to generate a text response.

Example Clause 34: The method of any one of Example Clauses 20-33, where the second model is configured to use a retrieval-augmented generation (RAG) system.

Example Clause 35: A system may include: one or more processors configured to: receive, at a computing device, a query from a user device, where the query may include a text portion and an image portion; cause the image portion and a spatial perspective prompt to be inputted into a multimodal model; receive spatial perspective information from the multimodal model; cause the image portion, the text portion, the spatial perspective information, and a render prompt to be inputted into the multimodal model, where the multimodal model generates, based on at least on the render prompt, image render instructions, and where the multimodal model causes the image render instructions to be delivered to an image renderer; receive an image answer rendered from the image renderer based on at least the image render instructions; cause the image portion, the text portion, the image answer, and a text generation prompt to be inputted into the multimodal model; receive a text answer from the multimodal model; generate a response based on at least one of the image answer or the text answer; and transmit the response to the user device.

Example Clause 36: The system of Example Clause 35, where the spatial perspective information may include camera angle information.

Example Clause 37: The system of Example Clause 35 or Example Clause 36, where the image render instructions may include at least one instruction to retrieve at least one first stored image asset.

Example Clause 38: The system of any one of Example Clauses 35-37, where the image render instructions may include at least one instruction to cause the at least one first stored image asset to be displayed according to the spatial perspective information.

Example Clause 39: The system of any one of Example Clauses 35-38, where the at least one first stored image asset is retrieved based on the image portion.

Example Clause 40: The system of any one of Example Clauses 35-39, where the image render instructions may include at least one instruction to retrieve at least one second stored image asset based on the text portion.

Example Clause 41: The system of any one of Example Clauses 35-40, where the image render instructions may include at least one instruction to highlight the at least one second stored image asset.

Example Clause 42: The system of any one of Example Clauses 35-41, where the image render instructions may include at least one instruction indicative of a location of the at least one second stored image asset relative to the at least one first stored image asset.

Example Clause 43: The system of any one of Example Clauses 35-42, where the generating a response based on at least one of the image answer or the text answer may include combining the image answer and the text answer into the response.

Example Clause 44: A system may include: one or more processors configured to: receive, at a computing device, a query from a user device, where the query may include one or more of a text portion or an image portion; cause, based on the one or more of the text portion or the image portion, a render prompt to be inputted into a multimodal model, where the multimodal model generates, based on at least on the render prompt, image render instructions, and where the multimodal model causes the image render instructions to be delivered to an image renderer; receive an image answer rendered from the image renderer based on at least the image render instructions; cause, based on at least the image answer, a text generation prompt to be inputted into the multimodal model; receive a text answer from the multimodal model; generate a response based on at least one of the image answer or the text answer; and transmit the response to the user device.

Example Clause 45: The system of Example Clause 44, where the one or more processors are further configured to: cause the image portion and a camera angle prompt to be inputted into the multimodal model; receive camera angle information from the multimodal model; and where the render prompt is further based on the camera angle information.

Example Clause 46: The system of Example Clause 44 or Example Clause 45, where the image render instructions may include at least one instruction to retrieve at least one first stored image asset.

Example Clause 47: The system of any one of Example Clauses 44-46, where the image render instructions may include at least one instruction to cause the at least one first stored image asset to be displayed according to the camera angle information.

Example Clause 48: The system of any one of Example Clauses 44-47, where the at least one first stored image asset is retrieved based on the image portion.

Example Clause 49: The system of any one of Example Clauses 44-48, where the image render instructions may include at least one instruction to retrieve at least one second stored image asset based on the text portion.

Example Clause 50: The system of any one of Example Clauses 44-49, where the image render instructions may include at least one instruction to highlight the at least one second stored image asset.

Example Clause 51: The system of any one of Example Clauses 44-50, where the image render instructions may include at least one instruction indicative of a location of the at least one second stored image asset relative to the at least one first stored image asset.

Example Clause 52: The system of any one of Example Clauses 44-51, where the generating a response based on at least one of the image answer or the text answer may include combining the image answer and the text answer into the response.

Example Clause 53: The system of any one of Example Clauses 44-52, where the text generation prompt is further based on one or more of the text portion or the image portion.

Example Clause 54: A system may include: one or more processors configured to: receive, at a computing device, a query from a user device, where the query may include one or more of a text portion or an image portion; cause, based on the one or more of the text portion or the image portion, a render prompt to be inputted into a first model, where the first model generates, based on at least on the render prompt, image render instructions, and where the first model causes the image render instructions to be delivered to an image renderer; receive an image answer rendered from the image renderer based on at least the image render instructions; cause, based on at least the image answer, a text generation prompt to be inputted into a second model; receive a text answer from the second model; generate a response based on at least one of the image answer or the text answer; and transmit the response to the user device.

Example Clause 55: The system of Example Clause 54, where the one or more processors are further configured to: cause the image portion and a camera angle prompt to be inputted into a third model; receive camera angle information from the third model; and where the render prompt is further based on the camera angle information.

Example Clause 56: The system of Example Clause 54 or Example Clause 55, where the image render instructions may include at least one instruction to retrieve at least one first stored image asset.

Example Clause 57: The system of any one of Example Clauses 54-56, where the image render instructions may include at least one instruction to cause the at least one first stored image asset to be displayed according to the camera angle information.

Example Clause 58: The system of any one of Example Clauses 54-57, where the at least one first stored image asset is retrieved based on the image portion.

Example Clause 59: The system of any one of Example Clauses 54-58, where the image render instructions may include at least one instruction to retrieve at least one second stored image asset based on the text portion.

Example Clause 60: The system of any one of Example Clauses 54-59, where the image render instructions may include at least one instruction to highlight the at least one second stored image asset.

Example Clause 61: The system of any one of Example Clauses 54-60, where the image render instructions may include at least one instruction indicative of a location of the at least one second stored image asset relative to the at least one first stored image asset.

Example Clause 62: The system of any one of Example Clauses 54-61, where the third model is configured to determine a spatial perspective.

Example Clause 63: The system of any one of Example Clauses 54-62, where the third model is configured to receive an image and determine a camera angle associated with the image.

Example Clause 64: The system of any one of Example Clauses 54-63, where the generating a response based on at least one of the image answer or the text answer may include combining the image answer and the text answer into the response.

Example Clause 65: The system of any one of Example Clauses 54-64, where the text generation prompt is further based on one or more of the text portion or the image portion.

Example Clause 66: The system of any one of Example Clauses 54-65, where the first model is configured to generate instructions for the image renderer.

Example Clause 67: The system of any one of Example Clauses 54-66, where the second model is configured to generate a text response.

Example Clause 68: The system of any one of Example Clauses 54-67, where the second model is configured to use a retrieval-augmented generation (RAG) system.

The foregoing disclosure provides illustration and description but is not intended to be exhaustive or to limit the implementations to the precise form disclosed. Modifications may be made in light of the above disclosure or may be acquired from practice of the implementations. As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein. As used herein, satisfying a threshold may, depending on the context, refer to a value being greater than the threshold, greater than or equal to the threshold, less than the threshold, less than or equal to the threshold, equal to the threshold, and/or the like, depending on the context. Although particular combinations of features are recited in the claims and/or disclosed in the specification, these combinations are not intended to limit the disclosure of various implementations. In fact, many of these features may be combined in ways not specifically recited in the claims and/or disclosed in the specification

Although each dependent claim listed below may directly depend on only one claim, the disclosure of various implementations includes each dependent claim in combination with every other claim in the claim set. No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method comprising:
receiving, at a computing device, a query from a user device, wherein the query comprises a text portion and an image portion;
causing the image portion and a spatial perspective prompt to be inputted into a multimodal model;
receiving spatial perspective information from the multimodal model;
causing the image portion, the text portion, the spatial perspective information, and a render prompt to be inputted into the multimodal model, wherein the multimodal model generates, based on at least on the render prompt, image render instructions, and wherein the multimodal model causes the image render instructions to be delivered to an image renderer;
receiving an image answer rendered from the image renderer based on at least the image render instructions;
causing the image portion, the text portion, the image answer, and a text generation prompt to be inputted into the multimodal model;
receiving a text answer from the multimodal model;
generating a response based on at least one of the image answer or the text answer; and
transmitting the response to the user device.

2. The method of claim 1, wherein the spatial perspective information comprises camera angle information.

3. The method of claim 1, wherein the image render instructions comprise at least one instruction to retrieve at least one first stored image asset.

4. The method of claim 3, wherein the image render instructions comprise at least one instruction to cause the at least one first stored image asset to be displayed according to the spatial perspective information.

5. The method of claim 4, wherein the at least one first stored image asset is retrieved based on the image portion.

6. The method of claim 5, wherein the image render instructions comprise at least one instruction to retrieve at least one second stored image asset based on the text portion.

7. The method of claim 6, wherein the image render instructions comprise at least one instruction to highlight the at least one second stored image asset.

8. The method of claim 7, wherein the image render instructions comprise at least one instruction indicative of a location of the at least one second stored image asset relative to the at least one first stored image asset.

9. The method of claim 1, wherein the generating a response based on at least one of the image answer or the text answer comprises combining the image answer and the text answer into the response.

10. A method comprising:
receiving, at a computing device, a query from a user device, wherein the query comprises one or more of a text portion or an image portion;
causing, based on the one or more of the text portion or the image portion, a render prompt to be inputted into a multimodal model, wherein the multimodal model generates, based on at least on the render prompt, image render instructions, and wherein the multimodal model causes the image render instructions to be delivered to an image renderer;
receiving an image answer rendered from the image renderer based on at least the image render instructions;
causing, based on at least the image answer, a text generation prompt to be inputted into the multimodal model;
receiving a text answer from the multimodal model;
generating a response based on at least one of the image answer or the text answer; and
transmitting the response to the user device.

11. The method of claim 10, further comprising:
causing the image portion and a camera angle prompt to be inputted into the multimodal model;
receiving camera angle information from the multimodal model; and
wherein the render prompt is further based on the camera angle information.

12. The method of claim 11, wherein the image render instructions comprise at least one instruction to retrieve at least one first stored image asset.

13. The method of claim 12, wherein the image render instructions comprise at least one instruction to cause the at least one first stored image asset to be displayed according to the camera angle information.

14. The method of claim 13, wherein the at least one first stored image asset is retrieved based on the image portion.

15. The method of claim 14, wherein the image render instructions comprise at least one instruction to retrieve at least one second stored image asset based on the text portion.

16. The method of claim 15, wherein the image render instructions comprise at least one instruction to highlight the at least one second stored image asset.

17. The method of claim 16, wherein the image render instructions comprise at least one instruction indicative of a location of the at least one second stored image asset relative to the at least one first stored image asset.

18. The method of claim 10, wherein the generating a response based on at least one of the image answer or the text answer comprises combining the image answer and the text answer into the response.

19. The method of claim 10, wherein the text generation prompt is further based on one or more of the text portion or the image portion.

20. A method comprising:
receiving, at a computing device, a query from a user device, wherein the query comprises one or more of a text portion or an image portion;
causing, based on the one or more of the text portion or the image portion, a render prompt to be inputted into a first model, wherein the first model generates, based on at least on the render prompt, image render instructions, and wherein the first model causes the image render instructions to be delivered to an image renderer;
receiving an image answer rendered from the image renderer based on at least the image render instructions;
causing, based on at least the image answer, a text generation prompt to be inputted into a second model;
receiving a text answer from the second model;
generating a response based on at least one of the image answer or the text answer; and
transmitting the response to the user device.

21. The method of claim 20, further comprising
causing the image portion and a camera angle prompt to be inputted into a third model;
receiving camera angle information from the third model; and
wherein the render prompt is further based on the camera angle information.

22. The method of claim 21, wherein the image render instructions comprise at least one instruction to retrieve at least one first stored image asset.

23. The method of claim 22, wherein the image render instructions comprise at least one instruction to cause the at least one first stored image asset to be displayed according to the camera angle information.

24. The method of claim 23, wherein the at least one first stored image asset is retrieved based on the image portion.

25. The method of claim 24, wherein the image render instructions comprise at least one instruction to retrieve at least one second stored image asset based on the text portion.

26. The method of claim 25, wherein the image render instructions comprise at least one instruction to highlight the at least one second stored image asset.

27. The method of claim 26, wherein the image render instructions comprise at least one instruction indicative of a location of the at least one second stored image asset relative to the at least one first stored image asset.

28. The method of claim 21, wherein the third model is configured to determine a spatial perspective.

29. The method of claim 21, wherein the third model is configured to receive an image and determine a camera angle associated with the image.

30. The method of claim 20, wherein the generating a response based on at least one of the image answer or the text answer comprises combining the image answer and the text answer into the response.

31. The method of claim 20, wherein the text generation prompt is further based on one or more of the text portion or the image portion.

32. The method of claim 20, wherein the first model is configured to generate instructions for the image renderer.

33. The method of claim 20, wherein the second model is configured to generate a text response.
